(19) United States
(12) Patent Application Publication
(10) Pub. No.: US 2021/0065138 A1
(43) Pub. Date: Mar. 4, 2021

(54) METHOD AND APPARATUS FOR ASSET MANAGEMENT

(71) Applicant: Copperleaf Technology Inc., Vancouver (CA)

(72) Inventors: Stanley Thomas Coleman, North Vancouver (CA); Thomas Stanley Coleman, North Vancouver (CA)

(21) Appl. No.: 16/558,805

(22) Filed: Sep. 3, 2019

(51) Int. Cl. G06Q 10/00; G06Q 10/06; G06Q 50/06

(52) U.S. Cl. CPC G06Q 10/20; G06Q 50/06; G06Q 10/06315

(57) ABSTRACT

Methods and apparatus for asset management is provided. The apparatus, for example, includes an input/output device; and a processor programmed to: receive an input from a user via the input/output device, the input including information relating to assets maintained by the user; determine, based on the input, if a second asset that has not failed should be bundled with a first asset that has one of failed or has a high probability of failure such that both the first asset and the second asset are replaced together; and upon receiving a request from a user, output a result of the determination to the user via one of a display of the input/output device or remote electronic device in communication with the asset management apparatus.

### FIELD

The present disclosure relates, generally, to methods and apparatus used for asset management, and more particularly, to methods and apparatus that use an asset bundling algorithm for determining replacement strategies when one or more assets need to be replaced or refurbished.

### BACKGROUND

Many businesses face challenges in managing large numbers of pieces of equipment or other assets, e.g., utility poles, pipeline, railroad tracks, cable, etc. An example of such a challenge is determining when to replace or refurbish assets. In making this determination businesses will typically attempt to sensibly balance many competing considerations. These considerations may vary between assets of different types and/or among assets of the same type, and may change over time. The complexity of the considerations that go into determining when to replace or refurbish an in-place asset, e.g., a utility pole, is frequently compounded by the fact that any decision regarding one particular asset often constrains or otherwise impacts decisions made about other assets.

The assets maintained by a typical larger organization is a complex system that requires maintenance to continue to operate smoothly to provide production for the organization. Furthermore, many organizations have a sufficiently large pool of assets which can make it impossible to maintain production without careful scheduling of maintenance and replacement of various assets.

For example, some organizations, e.g., a power company, can have in excess of one million power poles or electrical poles that need to be maintained. Accordingly, when one of the poles fail and needs to be replaced (e.g., due to catastrophic failure) or refurbished, it may prove advantageous and/or cost effective to additionally replace or refurbish one or more neighboring poles while the technicians are already at the job-site replacing the pole that failed.

Accordingly, the inventor has provided methods and apparatus that use an asset bundling algorithm for determining replacement strategies when one or more assets need to be replaced.

### SUMMARY

In accordance with an aspect of the present disclosure, there is provided an asset management apparatus. The asset management apparatus includes an input/output device; and a processor programmed to: receive an input from a user via the input/output device, the input including information relating to assets maintained by the user; determine, based on the input, if a second asset that has not failed should be bundled with a first asset that has one of failed or has a high probability of failure such that both the first asset and the second asset are replaced together; and upon receiving a request from a user, output a result of the determination to the user via one of a display of the input/output device or remote electronic device in communication with the asset management apparatus.

In accordance with an aspect of the present disclosure, there is provided an asset management apparatus. The asset management apparatus includes an input/output device; and a processor programmed to: receive an input from a user via the input/output device, the input including information relating to assets maintained by the user; receive a request from the user when a first asset fails; determine, based on the input, when the first asset fails, if a second asset that has not failed should be bundled with the first asset such that both the first asset and the second asset are replaced together; and output a result of a determination to the user via one of a display of the input/output device or remote electronic device in communication with the asset management apparatus.

In accordance with an aspect of the present disclosure, there is provided a non-transitory computer readable storage medium having stored thereon a plurality of instructions that when executed by a processor of an asset management apparatus perform a method for asset management. The method includes receiving an input from a user via an input/output device of the asset management apparatus, the input including information relating to assets maintained by the user; determining, based on the input, if a second asset that has not failed should be bundled with a first asset that has one of failed or has a high probability of failure such that both the first asset and the second asset are replaced together; and upon receiving a request from the user when a first asset fails outputting a result of the determination to the user via one of a display of the input/output device or remote electronic device in communication with the asset management apparatus.

Other and further embodiments of the present disclosure are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1 is a diagram of an asset management device, in accordance with an embodiment of the present disclosure;

FIGS. 2A-2D are diagrams of graphical user interfaces (GUIs), in accordance with an embodiment of the present disclosure;

FIG. 3 is a flowchart of a method for asset management, in accordance an embodiment of the present disclosure; and

FIG. 4 is a flowchart of a method for asset management, in accordance an embodiment of the present disclosure.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

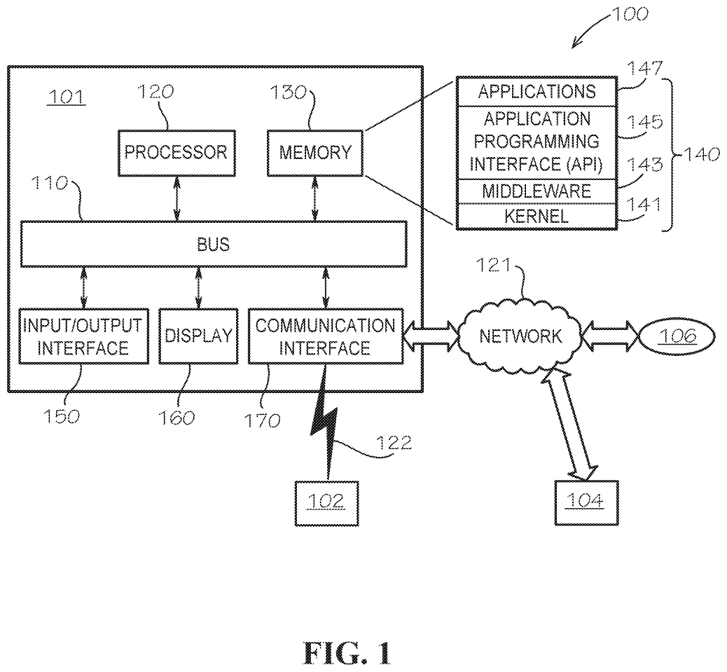

Referring to FIG. 1, a diagram of an asset management apparatus embodied in an electronic device 101 (e.g., desktop computer, PC, mobile phone, laptop, server, cloud-based server, or other suitable computing device) that is configured to operate in a network environment 100 is shown. The electronic device 101 includes a bus 110, a processor 120, a memory 130, an input/output device 150, a display 160, and a communication interface 170. At least one of the above described components may be omitted from the electronic device 101 or another component may be further included in the electronic device 101.

The bus 110 may be a circuit connecting the above described components 120, 130, and 150-170 and transmitting communications (e.g., control messages and/or data) between the above described components.

The processor 120 may include one or more of a CPU, an application processor (AP), and/or a communication processor (CP). The processor 120 controls at least one of the other components of the electronic device 101 and/or processing data or operations related to communication. The processor 120, for example, can use one or more control (asset bundling) algorithms, which can be stored in the memory 130, to perform a method for asset management, as will be described in greater detail below.

The memory 130, which can be a non-transitory computer readable storage medium, may include volatile memory and/or non-volatile memory. The memory 130 stores data or commands/instructions related to at least one of other components of the electronic device 101. The memory 130 stores software and/or a program module 140. For example, the program module 140 may include a kernel 141, middleware 143, an application programming interface (API) 145, application programs (or applications) 147, etc. The kernel 141, the middleware 143 or at least part of the 1PI 245 may be called an operating system (OS).

The kernel 141 controls or manages system resources (e.g., the bus 110, the processor 120, the memory 130, etc.) used to execute operations or functions of other programs (e.g., the middleware 143, the API 145, and the applications 147). The kernel 141 provides an interface capable of allowing the middleware 143, the API 145, and the applications 147 to access and control/manage the individual components of the electronic device 101, e.g., when performing an asset bundling routine or operation.

The middleware 143 may be an interface between the API 145 or the applications 147 and the kernel 141 so that the API 145 or the applications 147 can communicate with the kernel 141 and exchange data therewith. The middleware 143 processes one or more task requests received from the applications 147 according to a priority. For example, the middleware 143 assigns a priority for use of system resources of the electronic device 101 (e.g., the bus 110, the processor 120, the memory 130, etc.) to at least one of the applications 147. For example, the middleware 143 processes one or more task requests according to a priority assigned to at least one application program, thereby performing scheduling or load balancing for the task requests. For example, when executing the applications 147, which can include an asset management application, different priorities can be assigned to one or more tasks of the asset management application so that a task having a higher priority can be performed prior to a task having a lower priority, e.g., storing data input by a user can have a relatively high priority, while updating a candidate asset in a database of the memory 130 can have a relatively low priority.

The API 145 may be an interface that is configured to allow the applications 147 to control functions provided by the kernel 141 or the middleware 143. The API 145 may include at least one interface or function (e.g., instructions) for file control, window control, image process, text control, or the like.

The input/output device 150 is capable of transferring instructions or data, received from the user or one or more remote (or external) electronic devices 102, 104 or the server 106, to one or more components of the electronic device 101. For example, the input/output device 150 can receive an input, e.g., entered via the display 160, a keyboard, or verbal command, from a user. The input can include information relating to assets maintained by the user, or the input can be in the form of a request, e.g., when a first asset has been selected to be replaced or fails, as will be described in greater detail below. The input/output device 150 is capable of outputting instructions or data, which can be received from one or more components of the electronic device 101, to the user or remote electronic devices.

The display 160 may include a liquid crystal display (LCD), a flexible display, a transparent display, a light emitting diode (LED) display, an organic LED (OLED) display, micro-electromechanical systems (MEMS) display, an electronic paper display, etc. The display 160 displays various types of content (e.g., texts, images, videos, icons, symbols, etc.). The display 160 may also be implemented with a touch screen. In this case, the display 160 receives touches, gestures, proximity inputs or hovering inputs, via a stylus pen, or a user's body.

The communication interface 170 establishes communication between the electronic device 101 and the remote electronic devices 102, 104 or a server 106 (which can include a group of one or more servers and can be a cloud-based server) connected to a network 121 via wired or wireless communication. The electronic device 101 may employ cloud computing, distributed computing, or client-server computing technology when connected to the server 106.

Wireless communication may employ, as cellular communication protocol, at least one of long-term evolution (LTE), LTE Advance (LTE-A), code division multiple access (CDMA), wideband CDMA (WCDMA), universal mobile telecommunications system (UMTS), wireless broadband (WiBro), and global system for mobile communication (GSM), which can be used for global navigation satellite systems (GNSS). The GNSS may include a global positioning system (GPS), global navigation satellite system (Glonass), Beidou GNSS (Beidou), Galileo, the European global satellite-based navigation system, according to GNSS using areas, bandwidths, etc. Wireless communication may also include short-range communication 122. Short-range communication may include at least one of wireless fidelity (Wi-Fi), Bluetooth (BT), near field communication (NFC), and magnetic secure transmission (MST).

Wired communication may include at least one of universal serial bus (USB), high definition multimedia interface (HDMI), recommended standard 232 (RS-232), and plain old telephone service (POTS). The network 121 may include at least one of the following: a telecommunications network, e.g., a computer network (e.g., local area network (LAN) or wide area network (WAN)), the Internet, and a telephone network.

Each of the remote electronic devices 102 and 104 and/or the server 106 may be of a type identical to or different from that of the electronic device 101. All or some of the operations performed in the electronic device 101 may be performed in the remote electronic devices 102, 104 or the server 106. When the electronic device 101 has to perform some functions or services automatically or in response to a request (e.g., when using the asset management application), the electronic device 101 may make a request for performing at least some functions relating thereto to the remote electronic device 102 or 104 or the server 106, instead of performing the functions or services by itself. The remote electronic devices 102, 104 or the server 106 may execute the requested functions or the additional functions, and may deliver a result of the execution to the electronic device 101. The electronic device 101 may provide the received result as it is or additionally process the received result and provide the requested functions or services. To achieve this, for example, cloud computing, distributed computing, or client-server computing technology may be used.

An asset management application (e.g., the application 147) includes a plurality of instructions that are executable by processor 120 using the API 145. The asset management application can be downloaded from the server 106 (or the remote electronic device 104) via the Internet over the network 121 (or from the remote electronic device 102 via, for example, the short-range communication 122) and installed in the memory 130 of the electronic device 101.

During an initial set-up of the asset management application on the electronic device 101, the processor 120 can display one or more a GUIs on the display 160 requesting that a user input one or more types of assets that requires managing. For illustrative purposes, it is assumed that the assets which require managing are one or more types of the aforementioned poles, which can fail due to, for example, a storm, weathering, vehicle collision, or other foreseeable catastrophe. As can be appreciated, one or more consequences can be attributed due to pole failure, e.g., outages to customers, repair costs, safety to employees and the public, fire hazard, etc., or a high probability that pole failure is imminent.

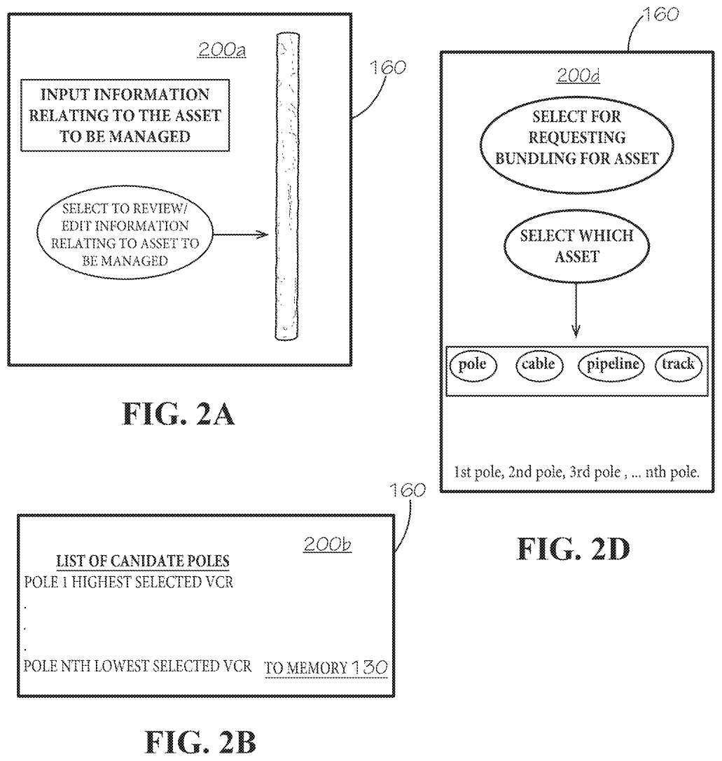

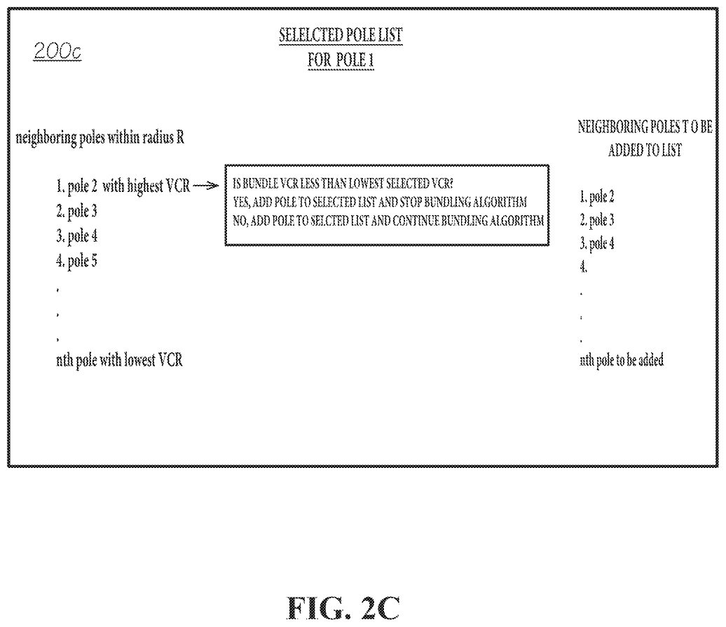

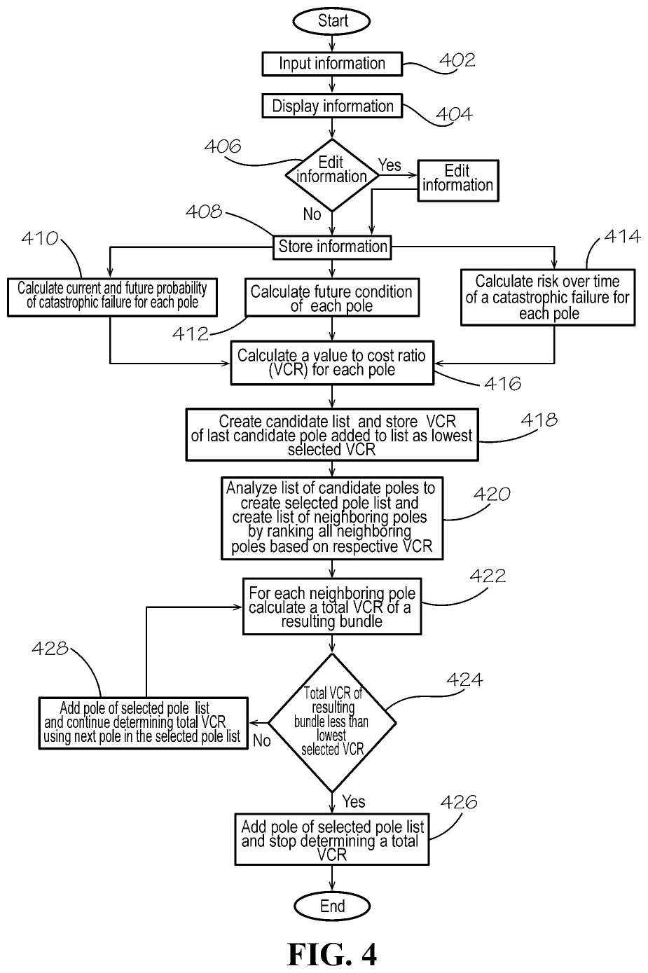

The processor 120 can display a GUI 200a (FIG. 2A) requesting that a user input information (see FIG. 4 at 402) relating to the poles to be managed by the asset management application so that the processor 120 can estimate and monetize a consequence of a catastrophic failure for each of the poles. For example, the information can relate to one or more attributes of each of the poles. The attributes can include, but is not limited to, a number or redundancy of circuits that a pole is a part of, a proximity of a pole in relation to roads, buildings, natural or unnatural structure, and/or an environment in which a pole is located. After the information relating to the poles is input, the processor 120 can display (see FIG. 4 at 404) a selectable area 201a on the display 160 so that the user can review/edit it (see FIG. 4 at 406), and/or can also display an image 203a of each of the poles, which can be uploaded and stored in the memory 130 during the initial set-up. The information relating to the asset can also be uploaded and stored in a memory (see FIG. 4 at 408) of the server 106, i.e., when the electronic device 101 uses an asset management application that is being executed at the server 106.

The processor 120, using the information relating to the poles, can calculate a current and future probability of a catastrophic failure of each of the poles based on a current condition and future condition of each of the poles (see FIG. 4 at 410). For example, the current probability can be calculated using an inspection of a pole, a parameter of a pole, and/or an environment in which a pole is located. For example, the inspection of a pole can be a measured remaining shell thickness or other real attribute of a pole, such as visible signs of deterioration, chips, dents, missing portions of a pole, etc. The inspection of a pole can be performed by a technician (or other qualified person) as part of a routine maintenance schedule for each of the poles. The information relating to the inspection can include photos or other images of a pole that can be input to electronic device 101 and stored in the memory 130. For example, the technician can use one or more of the remote electronic devices 102, 104 (e.g., mobile phone or other portable electronic device) to obtain the information relating to the inspection and can transmit, e.g., via the network 121, this information to the electronic device 101 (and/or upload it to the server 106), which can store the information in the memory 130 and/or display this information for reviewing and/or editing using, for example, the GUI 200a. When the information relating to the inspection is uploaded to the server 106, this information can be downloaded and/or viewed by any other electronic device that has the ability (e.g., clearance, authority, etc.) to do so.

The information relating to the parameter of the pole can include, but is not limited to, an installation date of a pole and/or a material type of a pole (e.g., wood, metal, etc.), and the information relating to the environment in which a pole is located can include, but is not limited to, an average temperature of a location in which a pole is located, general weather conditions in which a pole is located (e.g., rainy, dry, snowy, humidity, etc.) or a foundation in which a pole is set, e.g., cement, concrete, sand, stone, soil type, etc.

The processor 120, using the information relating to the poles, can determine the future condition of a pole based on a calculated degradation of the current condition of the pole, which is based on statistical analysis of poles (e.g., assets) that are similar to the pole for which the future condition of the pole is being determined (see FIG. 4 at 412).

The processor 120 calculates a risk over time (e.g., daily, monthly, yearly, etc.) of a catastrophic failure of a pole by computing a product of a probability and consequence of such an occurrence happening; a risk over time of a new replacement pole can be computed in a similar manner (see FIG. 4 at 414). The processor 120 also calculates a risk over time mitigated by replacing a pole by subtracting the risk over time of the replacement pole from the risk over time of the pole, and the processor 120 determines a value of replacing the pole by calculating the present value of the mitigated risk, that is, the value of replacing the pole is the equal to the net present value of the risk over time of the replacement pole subtracted from the net present value of the risk over time of the pole.

In addition to the foregoing, the information relating to the poles can also include budget constraint information associated with maintaining the poles. The budget constraint information includes a budget constraint value or an annual budget allowable for maintaining the poles. Thus, for given a budget constraint value, the processor 120 determines which additional pole(s) should be replaced (or refurbished) to provide a maximum possible value for an owner of the poles (e.g., a user of the asset management application). More particularly, the processor 120 uses all of the input information relating to the poles and the budget constraint value to calculate a value to cost ratio (VCR) for each of the poles, so that the processor 120 can quickly determine if it is advantageous to bundle two or more poles together with a pole that has been selected to be replaced, e.g., a pole has failed due to one or more of the above-disclosed reasons (see FIG. 4 at 416). A VCR for a bundle can be determined using, for example, a VCR for a pole 1+a VCR for a pole 2+a VCR for an nth pole+one or more other factors, including, but not limited to, a crew-distance-travel-factor (e.g., time of travel from pole 1 to pole 2, time of travel to depo (warehouse), etc.), reduced-outage-cost-factor (e.g., outage time reduction from parallel work or setup/takedown savings), material-travel-logistics-savings-factor (e.g., time of travel from pole 1 to pole 2, time of travel to depo, etc.).

More particularly, the processor 120 uses a control (asset bundling) algorithm of the asset management application for ranking all the poles stored in the memory 130 based on their respective VCR, which can be determined using the information relating to each of the poles and the budget constraint information, which was previously input and stored in the memory 130 of the electronic device 101 (or the server 106). The processor 120 creates a list of candidate poles (e.g., assets) by ranking all the poles based on a VCR of each of the poles, with a pole having a highest VCR being listed at a top of the list of candidate poles and remaining poles (e.g., assets) being listed in descending order based on a respective VCR of the remaining poles, e.g., by consuming the annual budget starting with a pole with the highest VCR and adding poles with lower VCRs until the entire annual budget is consumed (see FIG. 4 at 418). The processor 120 can display an editable GUI 200b on the display 160 so that a user can review/edit the information in the editable GUI 200b. The processor 120 stores the VCR of the last candidate pole added to the list as the lowest selected VCR in the memory 130; again, this information can also be transmitted to the remote electronic devices 102, 104 and/or uploaded to the server 106.

Next, the processor 120 traverses or analyzes the list of candidate poles from the highest VCR to the lowest VCR (see FIG. 4 at 420). More particularly, for each candidate pole in the list of candidate poles, the processor 120 creates a selected pole list (FIG. 2C), determines neighboring poles (e.g., assets) within a predetermined radius R (which can be determined based on a user input) of a pole that that has been selected to be replaced or fails, and creates a list of neighboring poles by ranking all neighboring poles based on a respective VCR of the neighboring poles. For example, a neighboring pole having a highest VCR can be listed at a top of the list of neighboring poles and remaining neighboring poles being listed in descending order based on a respective VCR of the remaining neighboring poles, i.e., similar to the ranking of the poles in the candidate list.

Neighboring poles can be poles that are within a predetermined radius (e.g., which can be measured in feet, yards, miles, meters, kilometers, or other suitable unit of measurement) of a pole that has been selected to be replaced or fails, can be poles that are on a same circuit of a pole that has been selected to be replaced or fails, or any other predetermined parameter selected or envisioned by a user. For example, the radius could be based on a distance that a crew can cover within a day.

For each neighboring pole, the processor 120 determines a total VCR of a resulting bundle, which is equal to a VCR of a neighboring pole (e.g., pole 2) in the list of neighboring pole and a VCR of a candidate pole for which the selected asset list is created, e.g., pole 1, (see editable GUI 200c of FIG. 2C and FIG. 4 at 422, for example). The processor 120 can do this for as many poles that are listed as a neighboring pole in the selected pole list for pole 1. If the processor 120 determines that a total VCR of the resulting bundle (e.g., pole 1 bundled with pole 2) is less than the lowest selected VCR (e.g., previously stored in the memory 130), the processor 120 adds pole 2 to the selected pole list for pole 1 and stops determining a total VCR of a resulting bundle for the remaining neighboring poles (see FIG. 4 at 424 and 426). Conversely, if the processor 120 determines that a total VCR of the resulting bundle (e.g., pole 1 bundled with pole 2) is greater than the lowest selected VCR, the processor 120 adds the pole 2 to the selected pole list for pole 1 list, and continues to the next pole (e.g., pole 3) listed as a neighboring pole in the selected pole list for pole 1 (see FIG. 4 at 424 and 428).

As the processor 120 compiles the selected pole list, e.g., selected pole list for pole 1, the processor 120 determines if a total cost of all neighboring poles in the selected pole list exceeds the budget constraint value. If the processor 120 determines that the total cost of all neighboring poles in the selected pole list exceeds the budget constraint value, the processor 120 stops determining a total VCR of a resulting bundle for the remaining neighboring poles, and displays the selected pole list including the neighboring poles (e.g., the poles 2-4) to the user using, for example, the GUI 202 on the display 160 of the input/output device 150 (interface) or a display of the remote electronic devices 102, 104 or the server 106 in communication with the electronic device 101.

The processor 120 also updates the list of candidate poles by removing the neighboring poles in the selected asset list (e.g., the poles 2-4) from the list of candidate list, and determines a new lowest selected VCR based on the remaining poles in the list of candidate poles.

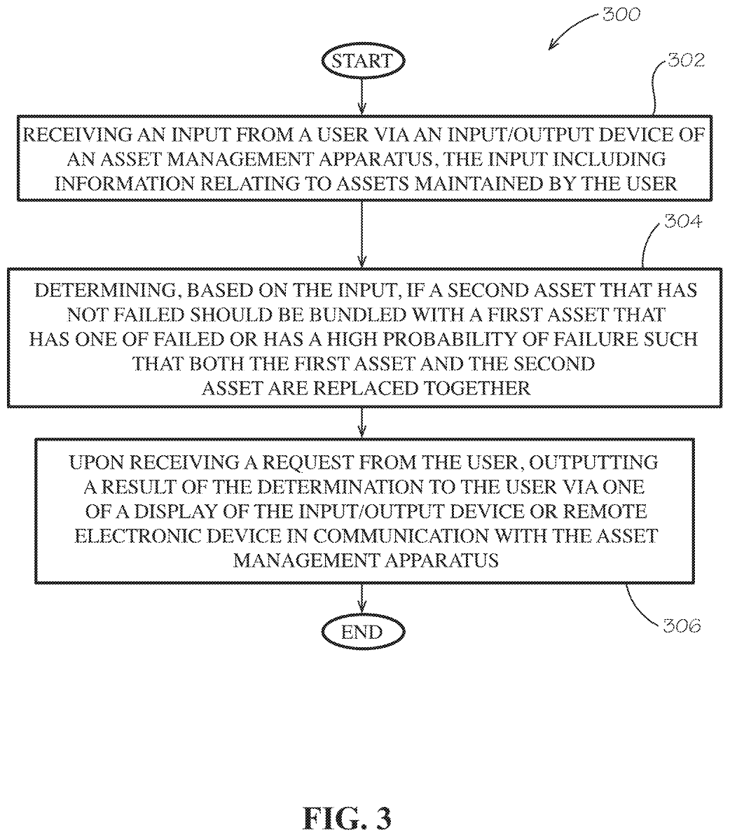

Referring to FIG. 3, a flowchart of a method 300 for asset management is shown. For illustrative purposes, the asset management apparatus is assumed to be the electronic device 101 and the first and second assets are assumed to be first and second poles, which can be telephone pole, power pole, electric pole, or other utility pole.

At 302, an input from a user via an input/output device (e.g., the input/output device 150) is received at the asset management apparatus (e.g., the electronic device 101). As described above, the input includes information relating to assets (e.g., poles) maintained by the user. The input can be transmitted or uploaded to the remote electronic devices 102,104 and/or to the server 106.

Next, a request (e.g., entered via the display 160) from the user can be received by the processor 120 when a first asset has been selected to be replaced or fails (e.g., a first pole is damaged or destroyed and needs replacing (or refurbishing)). For example, the processor 120 can display a GUI 200d (FIG. 2D) on the display 160. The GUI 200d includes a plurality of selectable areas that are configured to receive, for example, a touch input from a user. More particularly, the user can select a “request bundling for asset” tab 201d on the GUI 200d. The user can then select a “select asset tab” 203d and a “type of asset” tab 203e, e.g., pole, cable, pipeline, track, etc., for selecting a type of asset maintained by the user (e.g., an organization that owns the asset) and that needs to be bundled. For example, if a user selects the pole, the processor 120 can display a subsequent drop-down tab 205d that can be used for selecting a specific pole, e.g., a first pole, that needs to be replaced (or refurbished).

At 304, the processor 120 determines, based on the input, when the first asset has been selected to be replaced or fails, if a second asset (e.g., a second pole) that has not failed should be bundled with the first asset such that both the first asset and the second asset can be replaced together. As noted above, the processor 120 executes the control (asset bundling) algorithm of the asset management application to determine if the second pole (or one or more other neighboring poles located within a radius R) should be bundled with the first pole. The processor 120 can make such a determination for each of the poles at an initial set-up when the information is initially input to the electronic device 101, or the processor 120 can make the determination at the time that the request is received. Next, at 306, based on the determination, the processor 120 outputs a result of the determination to the user via one of a display 160 of the input/output device 150 or a display of a remote electronic device (e.g., the remote electronic devices 102, 104 or the server 106) that are in communication with the asset management apparatus.

Alternatively or additionally, the user can access the server 106 using one of the electronic device 101 and/or the remote electronic devices 102, 104 and can have the server 106, which can be a cloud-based server and can have the asset management application stored thereon, perform the operations 302-306. The server 106 can output the results of the determination on one of the respective displays of the electronic device 101 and/or the remote electronic devices 102, 104.

Using the methods and apparatus described herein, allows a user (or organization) to determine replacement (or refurbishing) or bundling strategies in a relatively quick (e.g., in less than a minute) and cost-effective manner.

While the herein described methods and apparatus use the asset management application for bundling poles, the disclosure is not so limited. For example, the asset management application installed on the electronic device 101 (or the remote electronic devices 102, 104 and/or server 106) can be used to bundle one or more other assets including, but not limited to, pipes, traffic lights, other utility assets, railroad tracks, or any other generalized asset.

In addition, a processor 120 that uses the control (asset bundling) algorithm of the asset management application can be programmed or otherwise configured to find any and all assets within a distance R, or can be programmed or otherwise configured to be more generalized to find all the assets that have a potential benefit to bundling (i.e., the cost savings need not solely be based on geographic proximity). For example, if a pole has been selected to be replaced or fails for any of the previously described reasons, the asset management application can be programmed or otherwise configured to bundle the pole with a different type of asset, e.g., pipeline, track, etc.

Moreover, when the processor 120 uses the control (asset bundling) algorithm to determine the VCR, other factors in addition to those described above can also be used. As can be appreciated, this will depend on a type of asset that the control (bundling) is programmed or otherwise to bundle, as each asset can have potential benefits that are more or less important than other assets.

While the foregoing is directed to embodiments of the present disclosure, other and further embodiments of the disclosure may be devised without departing from the basic scope thereof.

1. An asset management apparatus comprising:
an input/output device; and
a processor programmed to:
receive an input from a user via the input/output device, the input including information relating to assets maintained by the user;
determine, based on the input, if a second asset that has not failed should be bundled with a first asset that has one of failed or has a high probability of failure such that both the first asset and the second asset are replaced together; and
upon receiving a request from the user, output a result of the determination to the user via one of a display of the input/output device or remote electronic device in communication with the asset management apparatus.

2. The asset management apparatus of claim 1, wherein the first asset and the second asset are a first pole and a second pole comprising one of a telephone pole, power pole, electric pole, or other utility pole.

3. The asset management apparatus of claim 1, wherein the processor, using the input, is further configured to estimate and monetize a consequence of a catastrophic failure of the first asset based on at least one attribute of the first asset.

4. The asset management apparatus of claim 3, wherein the at least one attribute of the first asset is one of a number or redundancy of circuits that the first asset is a part of, a proximity of the first asset in relation to one of roads, buildings, natural or unnatural structure, or an environment in which the first asset is located.

5. The asset management apparatus of claim 4, wherein the processor, using the input, is further configured to calculate a current and future probability of the catastrophic failure of the first asset based on a current condition and future condition of the first asset.

6. The asset management apparatus of claim 5, wherein the current condition of the first asset is based on one of an inspection of the first asset, a parameter of the first asset, or the environment in which the first asset is located,
wherein the inspection of the first asset comprises a measured remaining shell thickness of the first asset,
wherein the parameter of the first asset comprises one of an installation date of the first asset or a material type of the first asset, and
wherein the environment in which the first asset is located comprises one an average temperature of a location in which the first asset is located or a foundation in which the first asset is set.

7. The asset management apparatus of claim 5, wherein the processor, using the input, is further configured to determine the future condition of the first asset based on a calculated degradation of the current condition of the first asset, which is based on statistical analysis of assets similar to the first asset.

8. The asset management apparatus of claim 1, wherein the information relating to assets maintained by the user includes budget constraint information associated with maintaining the assets of the user.

9. The asset management apparatus of claim 8, wherein the processor, using the input, is further configured to:
create a list of candidate assets by ranking all the assets based on a value to cost ratio (VCR), with an asset having a highest VCR being listed at a top of the list of candidate assets and remaining assets being listed in descending order based on a respective VCR of the remaining assets; and
store in a database of a memory of the asset management apparatus a VCR of a last candidate asset as a lowest selected VCR.

10. The asset management apparatus of claim 9, wherein for each candidate asset in the list of candidate assets, the processor is further configured to:
create a selected asset list;
determine neighboring assets within a predetermined radius; and
create a list of the neighboring assets by ranking all the neighboring assets based on a respective VCR of the neighboring assets, with a neighboring asset having a highest VCR being listed at a top of the list of the neighboring assets and remaining neighboring assets being listed in descending order based on the respective VCR of the remaining neighboring assets.

11. The asset management apparatus of claim 10, wherein for each neighboring asset, the processor is further configured to:
determine a total VCR of a resulting bundle, which is equal to a VCR of a neighboring asset in the list of the neighboring assets and a VCR of a candidate asset for which the selected asset list is created;
if a determined total VCR of the resulting bundle is less than the lowest selected VCR, stop determining a total VCR of a resulting bundle for the remaining neighboring assets; and
if the determined total VCR of the resulting bundle is greater than the lowest selected VCR, add the neighboring asset to the selected asset list.

12. The asset management apparatus of claim 11, wherein if the determined total VCR is greater than the lowest selected VCR, the processor is further configured to:
determine if a total cost of all the neighboring assets in the selected asset list exceeds a budget constraint value included in the budget constraint information, and if the total cost of all the neighboring assets in the selected asset list exceeds the budget constraint value, stop determining a total VCR of a resulting bundle for the remaining neighboring assets; and
display the selected asset list including the neighboring assets to the user via one of the display of the input/output device or the remote electronic device in communication with the asset management apparatus.

13. The asset management apparatus of claim 12, wherein if the total cost of all the neighboring assets in the selected asset list exceeds the budget constraint value, the processor is further configured to:
update the list of candidate assets by removing the neighboring assets in the selected asset list from the list of candidate assets; and
determine a new lowest selected VCR based on remaining assets in the list of candidate assets.

14. An asset management apparatus comprising:
an input/output device; and
a processor programmed to:
receive an input from a user via the input/output device, the input including information relating to assets maintained by the user;
receive a request from the user when a first asset fails;
determine, based on the input, when the first asset fails, if a second asset that has not failed should be bundled with the first asset such that both the first asset and the second asset are replaced together; and
output a result of the determination to the user via one of a display of the input/output device or remote electronic device in communication with the asset management apparatus.

15. A non-transitory computer readable storage medium having stored thereon a plurality of instructions that when executed by a processor of an asset management apparatus perform a method for asset management comprising:
receiving an input from a user via an input/output device of the asset management apparatus, the input including information relating to assets maintained by the user;
determining, based on the input, if a second asset that has not failed should be bundled with a first asset that has one of failed or has a high probability of failure such that both the first asset and the second asset are replaced together; and
upon receiving a request from the user, outputting a result of the determination to the user via one of a display of the input/output device or remote electronic device in communication with the asset management apparatus.

16. The non-transitory computer readable storage medium of claim 15, wherein the first asset and the second asset are a first pole and a second pole comprising one of telephone pole, power pole, electric pole, or other utility pole.

17. The non-transitory computer readable storage medium of claim 15, wherein the information relating to assets maintained by the user includes budget constraint information associated with maintaining the assets of the user.

18. The non-transitory computer readable storage medium of claim 17, further comprising:
creating a list of candidate assets by ranking all the assets based on a value to cost ratio (VCR), with an asset having a highest VCR being listed at a top of the list of candidate assets and remaining assets being listed in descending order based on a respective VCR of the remaining assets; and
storing in a database of a memory of the asset management apparatus a VCR of a last candidate asset as a lowest selected VCR.

19. The non-transitory computer readable storage medium of claim 18, further comprising, for each candidate asset in the list of candidate assets:
creating a selected asset list;
determining neighboring assets within a predetermined radius; and
creating a list of the neighboring assets by ranking all the neighboring assets based on a respective VCR of the neighboring assets, with a neighboring asset having a highest VCR being listed at a top of the list of the neighboring assets and remaining neighboring assets being listed in descending order based on the respective VCR of the remaining neighboring assets.

20. The non-transitory computer readable storage medium of claim 19, further comprising, for each neighboring asset:
determining a total VCR of a resulting bundle, which is equal to a VCR of a neighboring asset in the list of the neighboring assets and a VCR of a candidate asset for which the selected asset list is created;
if a determined total VCR of the resulting bundle is less than the lowest selected VCR, stopping determining a total VCR of a resulting bundle for the remaining neighboring assets; and
if the determined total VCR of the resulting bundle is greater than the lowest selected VCR, adding the neighboring asset to the selected asset list.
